(19) United States
(12) Patent Application Publication
(10) Pub. No.: US 2010/0269760 A1
(43) Pub. Date: Oct. 28, 2010

(54) APPARATUS AND METHODS FOR MONITORING AQUATIC ORGANISMS

(76) Inventor: Alan W. Cibuzar, Brainerd, MN (US)

Correspondence Address: Cardle Patent Law, Chtd., 406 W. Washington St., Suite 5 #208, Brainerd, MN, 56401, US

(21) Appl. No.: 12/753,872

(22) Filed: Apr. 3, 2010

Related U.S. Application Data
(60) Provisional application No. 61/171,589, filed on Apr. 22, 2009.

(51) Int. Cl. A01K 61/00; B63B 22/00; G09F 3/00; G01F 23/30

(52) U.S. Cl. 119/234; 441/1; 40/299.01; 119/200; 73/309

(57) ABSTRACT

Apparatus and related methods of monitoring a target aquatic organism are disclosed herein. In various aspects, the apparatus may include support media that supports the growth of a target aquatic organism, and a buoy adapted to float upon a water surface. The water surface may define a waterline with respect to the buoy, and the buoy may cooperate with the support media such that a waterline position of the waterline is generally indicative of a weight of the support media. The methods, in various aspects, may include the steps of positioning a support media in an aqueous environment, the support media supports the growth of a target aquatic organism, and determining a waterline position defined by a water surface with respect to a buoy, the waterline indicating a weight of the support media.

### CROSS REFERENCE TO RELATED APPLICATIONS

This application claims priority and benefits of U.S. Provisional Application No. 61/171,589 filed 22 Apr. 2009, which is hereby incorporated by reference in its entirety herein.

### BACKGROUND OF THE INVENTION

Monitoring of water quality is important for the maintenance of the quality of natural and man-made water bodies. In various applications, it may be necessary to monitor water quality over large areas, such as portions of Lake Superior, and to monitor water quality over long periods of time. In order to monitor water quality, the activity of various target aquatic organisms that may be indicative of either good water quality or poor water quality may be monitored. Invasive species such as the zebra mussel are a concern, so that water quality monitoring may include monitoring of invasive species. Accordingly, improved apparatus for monitoring water quality including the monitoring of various target aquatic organisms within a water body are needed.

### BRIEF SUMMARY OF THE INVENTION

These and other needs and disadvantages are overcome by the monitoring apparatus and associated methods disclosed herein. Additional improvements and advantages may be recognized by those of ordinary skill in the art upon study of the present disclosure. In various aspects, the monitoring apparatus includes support media that supports the growth of a target aquatic organism, and a buoy adapted to float upon a water surface, the water surface defines a waterline with respect to the buoy, the buoy cooperates with the support media such that a waterline position of the waterline is generally indicative of a weight of the support media. The methods disclosed herein in various aspects include the step of positioning a support media in an aqueous environment, the support media supports the growth of a target aquatic organism, and the step of determining a waterline position defined by a water surface with respect to a buoy, the waterline indicating a weight of the support media

### BRIEF DESCRIPTION OF THE DRAWINGS

FIG. 1A illustrates by elevation view an exemplary implementation of the monitoring apparatus;

FIG. 1B illustrates by elevation view another exemplary implementation of the monitoring apparatus;

FIG. 2 illustrates by a cut-away elevation view portions of the exemplary implementation of the monitoring apparatus of FIG. 1A;

FIG. 3 illustrates by flow chart an exemplary method of monitoring a target aquatic organism;

FIG. 4A illustrates by top view an exemplary implementation of a support media;

FIG. 4B illustrates by front perspective view another exemplary implementation of a support media; and

FIG. 4C illustrates by front perspective view another exemplary implementation of a support media.

The Figures are exemplary only and the implementations illustrated therein are selected to facilitate explanation. The number, position, relationship and dimensions of the parts shown in the Figures to form the various implementations described herein, as well as dimensions and dimensional proportions to conform to specific force, weight, strength, flow and similar requirements, are explained herein or are understandable to a person of ordinary skill in the art upon study of this disclosure. Where used in various Figures, the same numerals designate the same or similar parts. Furthermore, when the terms “top,” “bottom,” “right,” “left,” “forward,” “rear,” “first,” “second,” “inside,” “outside,” and similar terms are used, the terms should be understood in reference to the orientation of the structures shown in the drawings and are utilized to facilitate understanding.

### DETAILED DESCRIPTION OF THE INVENTION

A monitoring apparatus and associated methods are disclosed herein for the monitoring of one or more target aquatic organisms in a water body. In various aspects, the monitoring apparatus includes a buoy and a support media. The buoy and support media may be placed in a water body, which could be, for example, a pond, a lake, an estuary, a river, or a man-made water body such as a reservoir or a sewage lagoon, such that the buoy floats upon the surface of the water body and the support media is accessible to one or more target aquatic organism(s) within the water body.

The support media may be formed of materials such that the target aquatic organism(s) may, for example, grow upon the support media or feed upon the support media. In various aspects, the support media may be shaped or otherwise configured to be conducive for the target aquatic organism(s) to grow thereupon, or attractive for the target aquatic organism(s) to feed thereupon.

The support media is connected to the buoy such that the weight of the support media is communicated to the buoy. The water surface defines a waterline with respect to the buoy, the waterline position of the waterline being generally indicative of the volume of water displaced by the buoy, and accordingly, the waterline position is generally indicative of at least the weight of the buoy and the weight of the support media connected to the buoy. An alteration of the weight of the support media alters the volume of water displaced by the buoy and thus alters the waterline position. By determining the waterline position, the weight of the support media may be determined. For example, in aspects wherein the target aquatic organism grows upon the support media, the weight of the support media is increased according to the weight of the target aquatic organisms growing upon the support media, which changes the waterline position of the waterline. The weight of the target aquatic organisms growing upon the support media may be related to the size and/or number of target aquatic organisms growing thereupon. Thus, the size and/or number of target aquatic organisms of the target aquatic organism growing upon the support media (i.e. the growth of the target aquatic organism) may be monitored by determining the waterline position of the waterline. Similarly, in aspects wherein the target aquatic organism feeds upon the support media, the weight of the support media would decrease as the target aquatic organism erodes the support media by feeding upon the support media, which changes the waterline position of the waterline. The erosion of the support media due to feeding thereupon by the target aquatic organism may be determined by determining the waterline position of the waterline.

The waterline position of the waterline may be determined visually in some aspects. For example, indicia may be place upon the outer surface of the buoy so that an observer could visually determine the waterline position by visually observing the relationship of the water surface with respect to the indicia. The indicia may be formed to be visible from a distance in order to allow the observer to visually determine the waterline position from some distance away from the buoy.

In other aspects, one or more sensors are placed about the buoy, and the one or more sensors determine the waterline position. The one or more sensors may then cooperate with a radio transmitter to transmit the waterline position to a remote monitoring station. The waterline position may be collected into a data set, analyzed, and otherwise processed at the remote monitoring station. A number of monitoring apparatus may be deployed over a particular water body or over a number of water bodies, and the remote monitoring station may collect the waterline position data from these monitoring apparatus.

In this disclosure, the target aquatic organism is any aquatic organism or group of aquatic organisms the presence of which or the activity of which it may be desirous to monitor. In various aspects, the target aquatic organism may be a mussel such as a zebra mussel. In various aspects, the target aquatic organism may be periphyton. The target aquatic organism includes other aquatic organisms and groups of aquatic organisms as would be recognized by those of ordinary skill in the art upon review of this disclosure.

The methods disclosed herein in various aspects include the steps of positioning a support media in an aqueous environment, the support media supports the growth of a target aquatic organism, and determining a waterline position of a waterline defined by a water surface with respect to a buoy, the waterline position of the waterline indicating a weight of the support media.

The Figures referenced herein generally illustrate various exemplary implementations of the monitoring apparatus and associated methods and methods. These illustrated implementations are not meant to limit the scope of coverage, but, instead, to assist in understanding the context of the language used in this specification and in the claims. Accordingly, variations of the monitoring apparatus and associated methods that differ from these illustrated implementations may be encompassed by the appended claims that alone define the invention.

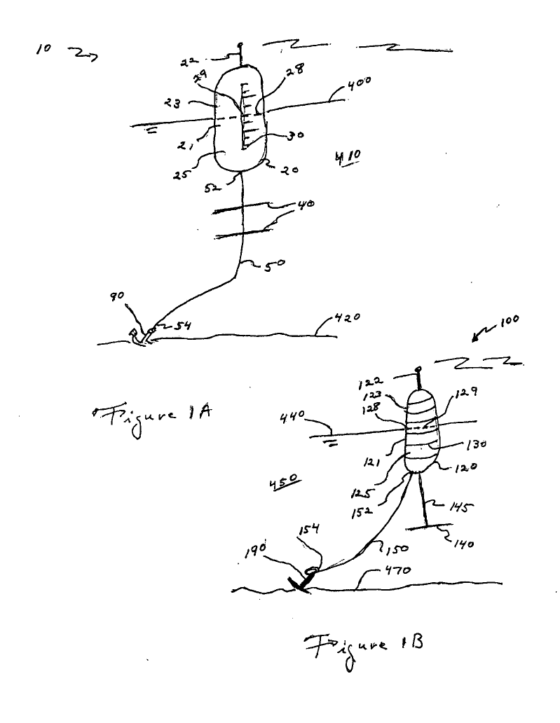

FIG. 1A illustrates an implementation of the monitoring apparatus 10. In the implementation of FIG. 1A, the monitoring apparatus 10 includes buoy 20, support media 40, mooring line 50, and anchor 90. As illustrated, the buoy 20 is secured to mooring line end 52 of mooring line 50. Mooring line 50 extends from mooring line end 52 to mooring line end 54, and mooring line end 54 is secured to anchor 90 in water body 410. The anchor 90 rests upon the bottom 420 of water body 410 to hold the buoy 20 and support media 40 generally in a fixed location within the water body 410, as illustrated. In other implementations, the mooring line 50 could secure the buoy 20 in position in other ways such as by attachment to a cleat or post or other mooring support. A plurality of mooring lines 50 could be provided in some implementations. In some implementations, the mooring line 50 may be omitted so that the buoy 20 drifts free. A plurality of support media 40 are attached to the mooring line 50 in this implementation at a location intermediate between mooring line end 52 and mooring line end 54, and the support media 40 is submerged beneath the buoy 20 to be accessible to the target aquatic organism within water body 410.

The buoy 20 in various implementations may be made, for example, of plastic, wood, metal such as steel or galvanized steel, combinations thereof, or other materials. The mooring line 50 may be, for example, a rope, strap, chain, or cable, and the mooring line 50 may be made of steel or various synthetic materials such as nylon. The anchor 94 may be made of metal, concrete, or other weighty materials and combinations of materials. The mooring line 50 may be tied, welded, or otherwise affixed to the buoy 20 and to the anchor 90, and eyes and suchlike may be disposed about the buoy 20 and the anchor 90 for the attachment of the mooring line 50 thereto. The support media 40 may be attached to the mooring line 50 in various ways including ways that may allow for adjustment of the location at which the support media, and various eyes and other such fittings may be provided about the support media 40 to attach the support media 40 to the mooring line 50.

As illustrated in FIG. 1A, water surface 400 defines waterline 28 (illustrated in phantom) with respect to buoy 20. Portion 23 of the buoy 20 lies above the water surface 400—i.e. above waterline 28—and a portion 21 of the buoy 20 lies below the water surface 400—i.e. below waterline 28—so that the buoy 20 displaces a volume of water equal to the volume of portion 21 of the buoy 20. The weight of the volume of water displace by portion 21 of buoy 20 generally equals the weight of the buoy 20 plus the weight of the support media 40, mooring line 50, and any other fittings and fixtures suspended from the buoy 20.

The buoy 20 defines buoy surface 25 as illustrated in FIG. 1A. Indicia 30 generally in the form of a scale are inscribed upon buoy surface 25 in this implementation, so that the waterline position 29 of the waterline 28 may be determined visually by reference to the indicia 30. As the weight of the support media 40 changes, the volume of portion 21 of buoy 20 changes, and the waterline position 29 of the waterline 28 changes with respect to the indicia 30. By determination of the waterline position 29 of the waterline 28 or changes in the waterline position 29 of the waterline 28 in reference to the indicia 30, the weight of the support media 40 and/or changes in the weight of the support media 40 may be determined.

In the implementation illustrated in FIG. 1A, the buoy 20 includes an antenna 22 to allow for radio communication between the buoy 20 and a remote monitoring station (not shown). Radio communication may include cellular telephone technologies, may include, at least in part communication via Internet, may include communication by light-wave based technologies, combinations thereof, and so forth.

FIG. 1B illustrates another implementation of the monitoring apparatus 100. In the implementation of FIG. 1B, the monitoring apparatus 100 includes buoy 120, support media 140, mooring line 150, and anchor 190. The anchor 190 rests upon the bottom 470 of water body 450 to hold the buoy 120 and support media 140 generally in a fixed location within the water body 450, as illustrated. As illustrated in FIG. 1B, the buoy 120 is secured the anchor 190 by mooring line 150. Mooring line end 152 of mooring line 150 is secured to the buoy 120 and mooring line end 154 of mooring line 150 is secured to anchor 90 in water body 450 to secure the buoy 120 to the anchor 190 as illustrated.

In this implementation illustrated in FIG. 1B, support media 140 is attached to the buoy 120 separate from mooring line 150 by connector 145. In some implementations connector 145 may be a rope, cable, chain, or suchlike that generally only resists a tension force, while, in other implementations, connector 145 may be a rod or other generally rigid structural member that resists both tension and compression forces. In still other implementations (not shown) the connector 145 may be omitted entirely, and the support media 140 secured generally directly to the buoy 120. The support media 140, as illustrated, is submerged beneath the buoy 20 to be accessible to the target aquatic organism in the water body 450.

As illustrated in FIG. 1B, water surface 440 defines waterline 128 (illustrated in phantom) on buoy 120. Portion 123 of the buoy 120 lies above the water surface 440—i.e. above waterline 128—and portion 121 of the buoy 120 lies below the water surface 440—i.e. below waterline 128—so that the buoy 120 displaces a volume of water equal to the volume of portion 121 of the buoy 120. The weight of the volume of water displace by portion 121 of buoy 120 generally equals the weight of the buoy 120 plus the weight of the support media 140, mooring line 150, connector 145, and any other fittings and fixtures suspended from the buoy 120.

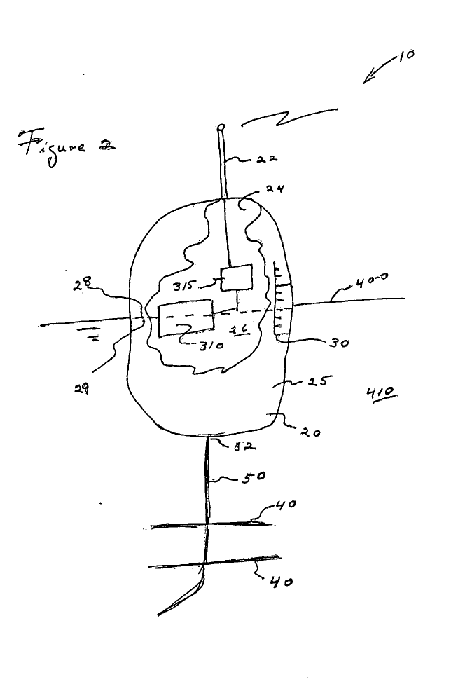

Indicia 130 in the form of a series of circumferential bands in this implementation are inscribed upon buoy surface 125, so that the waterline position 129 of the waterline 128 may be determined visually by reference to the indicia 130. In various aspects, the bands that form indicia 130 may be of varying color to facilitate visual determination of the waterline position 129 of the waterline 128. The indicia 130 may take other forms in other implementations. As the weight of the support media 140 changes, the volume of water displaced by portion 121 of buoy 210 changes, and the waterline position 129 of the waterline 128 changes with respect to the indicia 130. By determining the waterline position 129 of the waterline 128 in reference to the indicia 130, the weight of the support media 140 and/or changes in the weight of the support media 140 may be determined. The implementation illustrated in FIG. 1B includes an antenna 122 to allow for radio communication between the buoy 120 and a remote monitoring station (not shown) to transmit the waterline position 129 as detected by a sensor such as sensor 310 of FIG. 2.

FIG. 2 illustrates by cut-away view a portion of the monitoring apparatus 10 of FIG. 1A. As illustrated in FIG. 2, the buoy 20 defines buoy surface 24, and buoy surface 24 defines buoy cavity 26. The buoy cavity 26 may be substantially weatherproof and watertight to protect equipment such as electrical apparatus positioned within buoy cavity 26. In this implementation, a waterline sensor 310 is placed within buoy cavity 26. Waterline sensor 310 senses the waterline position 29 of the waterline 28. In various implementations, the waterline sensor 310 may employ a wave probe to determine the waterline position 29, may use sound waves to determine the waterline position 29, or may use other techniques as would be recognized by those of ordinary skill in the art upon study of this disclosure to locate the waterline position 29. The waterline sensor 310 in this implementation is operatively coupled to a radio transmitter 315. The radio transmitter 315 may communicate the waterline position 29 of the waterline 28 as determined by the waterline sensor 310 to a remote monitoring station by radio communication. Antenna 22 is coupled to the radio transmitter 315 for this purpose. Although not shown, a power source such as a battery or solar cell is included in various implementations to provide electrical power to the waterline sensor 310 and the radio transmitter 315 as well as other electrical apparatus that may be included. A microcontroller (not shown) is included in some implementations to control the waterline sensor 310 and the radio transmitter 315. The microcontroller may control the frequency with which the waterline sensor 310 determines the waterline position 29, and the microcontroller may analyze the water level position 29 determined by the water level sensor 310 to correct for wave motions and other phenomena. The time between determinations of the waterline position may be tracked in order to measure the rate of change of the waterline position. Accordingly, the waterline position may be recorded along with the corresponding time at which the waterline position was determined. In some implementations, processing and/or analysis of the water level position 29 determined by the water level sensor 310 is performed entirely at the remote monitoring station. Some implementations may include additional sensors such as sensors that measure water quality parameters such as temperature, salinity, turbidity, and/or sensors that measure meteorological parameters such as air temperature, wind speed, solar radiation, and these sensors may communicate with the remote monitoring station through the radio transmitter 315. The remote monitoring station may communicate to the microcontroller, sensor 310 or other electrical equipment placed about the buoy 20 in order to control the operation thereof, in various implementations.

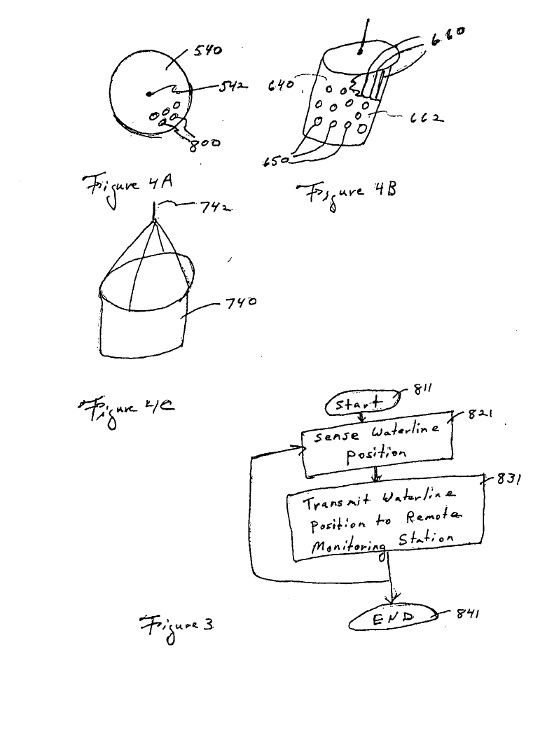

FIGS. 4A, 4B, and 4C illustrate various implementation of the support media 540, 640, 740, respectively. As illustrated in FIG. 4A, the support media 540 is formed as a disc that may be suspended from a buoy, such as buoy 20 or buoy 120, or from a mooring line, such as mooring line 50 or mooring line 150, by connector 542. In other implementations, the support media 540 may have a rectangular or other shape. The target aquatic organism may then grow upon the support media 540, as illustrated. For example, the support media 540 may be made of metal or plastic and the target aquatic organisms 800, zebra mussels for example, then grow upon the support media 540. The rate of increase of the weight of the support media 540 would correspond to the rate of growth of the target aquatic organism 800 on the support media 540 and may thus be indicative of the population dynamics of the target aquatic organism 800 in the vicinity.

Another implementation of support media 640 is illustrated in FIG. 4B. In this implementation, the support media is formed as a number of baffles 660 disposed within a cylindrical housing 662. Holes 650 are disposed about the housing 662 to allow water to flow through the housing 662 to contact the baffles 660. Pumping or suchlike may be provided in some implementation to facilitate the flow of water into contact with the baffles. The target aquatic organism then grows upon the baffles 660 in this implementation.

FIG. 4C illustrates another implementation of the support media 740. In this implementation, the support media 740 may be suspended by harness 742 from the buoy, such as buoy 20 or buoy 120, or from a mooring line, such as mooring line 50 or mooring line 150. The support media 740 has a generally cylindrical shape as illustrated and is formed of an edible material attractive to the target aquatic organism. In this implementation, the support media 740 is eroded by being eaten by the target aquatic organism. The rate of decreases of the weight of the support media 740 is correlated to the rate at which the support media 740 is eaten or otherwise eroded by the target aquatic organism, and may be indicative of the population and/or activity and/or other population dynamics of the target aquatic organism in the vicinity.

In operation, the monitoring apparatus, such as monitoring apparatus 10 or monitoring apparatus 100, may be positioned in a water body such as water body 410 or water body 450 such that the buoy, for example buoy 20 or buoy 120, floats upon the water surface, for example water surface 400 or water surface 440, of the water body. A mooring line, such as mooring line 50 or mooring line 150, with anchor, such as anchor 90 or anchor 190, is deployed so that the anchor engages the bottom, such as bottom 420 or bottom 470 of the water body to hold the buoy in a generally fixed location within the water body in various aspects. Support media, such as support media 40, support media 140, support media 540, support media 640, support media 740, may be deployed within the water body accessible to the target aquatic organism. The support media is connected to the buoy such that the weight of the support media is communicated to the buoy. Changes in the weight of the support media caused by growth of the target aquatic organism upon the support media or erosion of the support media by the target aquatic organism produce corresponding changes the waterline position, such as waterline position 29 or waterline position 129, of the waterline such as waterline 28 or waterline 128, defined by the water surface. Accordingly, the waterline position of the waterline may be determined upon deployment of the monitoring apparatus and then the waterline position of the waterline may be determined at intervals thereafter to determine changes in the weight of the support media caused by growth of the target aquatic organism upon the support media or erosion of the support media by the target aquatic organism.

The waterline position of the waterline may be determined visually in some aspects through the use of indicia such as indicia 30 or indicia 130. An observer could visually determine the waterline position by visually observing the relationship of the water surface with respect to the indicia. In other aspects, one or more sensors, such as sensor 310, are placed about the buoy, and the one or more sensors determine the waterline position. The one or more sensors may then cooperate with a radio transmitter, for example radio transmitter 315, to transmit the waterline position to a remote monitoring station. The waterline position is indicative of the weight of the support media, and the rate of change of the waterline position is indicative of the rate of change of the weight of the support media.

FIG. 3 illustrates by flow chart methods of monitoring the target aquatic organism. As illustrated in FIG. 3, the method includes step 821 of sensing the waterline position followed by step 831 of transmitting the waterline position to a remote monitoring station. Step 821 and step 831 may be repeated over some period of time. In some aspects the time between determinations of the waterline position may be tracked so that the rate of change of the waterline position can be calculated. In some aspects, the method may include the step of anchoring the buoy with support media secured thereto at a generally fixed location within the aqueous environment. In some aspects the method includes accumulating the waterline position at various times and determining the rate of change of the waterline position. In some aspects, the target aquatic organism grows upon the support media such that the waterline is indicative of the accumulation of the target aquatic organism upon the support media. In other aspects, the target aquatic organism erodes the support media such that the waterline is indicative of the erosion of the support media by the target aquatic organism, and the target aquatic organism may erode the support media by feeding upon the support media. The method, in some aspects, includes determining the waterline using a sensor disposed about the buoy. The method, in some aspects, includes determining visually the waterline using indicia disposed upon a surface of the buoy.

The foregoing along with the accompanying Figures discloses and describes various exemplary implementations of the monitoring apparatus and methods. Upon study thereof, one of ordinary skill in the art may readily recognize that various changes, modifications and variations can be made therein without departing from the spirit and scope of the inventions as defined in the following claims.

The invention claimed is:

1. An apparatus for the monitoring of aquatic organisms, comprising:
support media that supports the growth of a target aquatic organism; and
a buoy adapted to float upon a water surface, the water surface defines a waterline with respect to the buoy, the buoy cooperates with the support media such that a waterline position of the waterline is generally indicative of a weight of the support media.

2. The apparatus, as in claim 1, further comprising:
an anchor; and
a mooring line with an end thereof attached to the buoy and an opposing end thereof attached to the anchor to generally secure the buoy to the anchor.

3. The apparatus, as in claim 2, wherein the support media is affixed to the mooring line intermediate of the buoy and the anchor.

4. The apparatus, as in claim 1, wherein the target aquatic organism grows upon the support media such that the waterline is indicative of the accumulation of the target aquatic organism upon the support media.

5. The apparatus, as in claim 4, wherein the target aquatic organism comprises the zebra mussel.

6. The apparatus, as in claim 4, wherein the target aquatic organism comprises periphyton.

7. The apparatus, as in claim 1, wherein the target aquatic organism erodes the support media such that the waterline is indicative of the erosion of the support media by the target aquatic organism.

8. The apparatus, as in claim 7, wherein the target aquatic organism erodes the support media by feeding upon the support media.

9. The apparatus, as in claim 1, further comprising:
a sensor disposed about the buoy, the sensor adapted to determine the waterline.

10. The apparatus, as in claim 9, further comprising: a radio disposed about the buoy that cooperates with the sensor to communicate the waterline determined by the sensor to a monitoring station.

11. The apparatus, as in claim 1, further comprising:
indicia disposed upon a surface of the buoy to allow visual determination of the waterline.

12. A method for monitoring aquatic organisms, comprising:
positioning a support media in an aqueous environment, the support media supports the growth of a target aquatic organism; and
determining a waterline position defined by a water surface with respect to a buoy, the waterline indicating a weight of the support media.

13. The method, as in claim 12, further comprising:
anchoring the buoy with support media secured thereto at a generally fixed location within the aqueous environment.

14. The method, as in claim 12, wherein the target aquatic organism grows upon the support media such that the waterline is indicative of the accumulation of the target aquatic organism upon the support media.

15. The method, as in claim 14, wherein the target aquatic organism comprises the zebra mussel.

16. The method, as in claim 14, wherein the target aquatic organism comprises periphyton.

17. The method, as in claim 12, wherein the target aquatic organism erodes the support media such that the waterline is indicative of the erosion of the support media by the target aquatic organism.

18. The method, as in claim 17, wherein the target aquatic organism erodes the support media by feeding upon the support media.

19. The method, as in claim 12, further comprising:
determining the waterline using a sensor disposed about the buoy.

20. The apparatus, as in claim 19, further comprising:
communicating the waterline to a monitoring station using a radio disposed about the buoy, the radio cooperating with the sensor.

21. The apparatus, as in claim 1, further comprising:
determining visually the waterline using indicia disposed upon a surface of the buoy.
